(19) United States
(12) Patent Application Publication
(10) Pub. No.: US 2005/0121992 A1
(43) Pub. Date: Jun. 9, 2005

(54) Counteracting magnetic field generator for undesired axial magnetic field component of a power generator stator and associated methods

(75) Inventor: Vladimir Leonov, Oviedo, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/728,691

(22) Filed: Dec. 5, 2003

(51) Int. Cl. H02K 5/10; H02K 5/12

(52) U.S. Cl. 310/183; 310/85

(57) ABSTRACT

A power generator (20) includes a rotor (22), and a stator (23) surrounding the rotor and having opposing ends. The stator (23) includes a stator core (21) and a plurality of windings (28) carried by the stator core creating an undesired axial magnetic field component adjacent the opposing ends of the stator. The power generator (20) may also include at least one counteracting magnetic field generator (30) associated with at least one end of the stator (23) for generating a counteracting magnetic field for counteracting the undesired axial magnetic field component.

### FIELD OF THE INVENTION

The present invention relates to the field of power generation and, more particularly, to a power generator and related methods.

### BACKGROUND OF THE INVENTION

A typical power generator includes a shaft and a rotor carried by the shaft. Surrounding the generator rotor is a generator stator. A turbine, such as a gas combustion turbine, a water-driven turbine, or steam-driven turbine rotates the shaft. The generator rotor is supplied DC power typically from an exciter also driven by the shaft. As the generator rotor is turned within the generator stator, electrical power is produced and is delivered to the utility power grid. Rotation of the rotor within the stator may create an undesired axial magnetic field component adjacent opposing ends of the stator. The undesired axial magnetic field component may cause eddy currents that would undesirably heat up the ends of the stator, unless addressed.

U.S. Pat. No. 6,608,419 to Shah et al. discloses a stepped away portion at each end of the stator. To combat the build-up of heat due to axial magnetic flux at each end of the stator core, the inner surface is stepped away from the rotor to increase the distance between the rotor and the stator core along the ends of the stator core. The increased distance reduces the axial magnetic flux on the ends of the stator core.

Multiple flux shunts are also disclosed in the Shah et al. patent. The flux shunts are positioned adjacent the stepped away portion of the prior art power generator to attract and redistribute the axial magnetic flux. The flux shunts attract and redistribute the axial magnetic flux by providing a low reluctance path for the undesired axial magnetic flux produced by rotation of the rotor.

U.S. Pat. No. 6,525,444 to Salem et al. discloses a laminate for reducing eddy currents and heating in a stator core to increase generator capacity. The metal lamination package comprises alternate layers of amorphous metal laminate and non-amorphous metal laminate.

Despite the above disclosed approaches to reduce an undesired axial magnetic field component in a power generator, it is still desirable to provide a more efficient and effective way to reduce, or counteract, the undesired axial magnetic field component at the ends of the stator.

### SUMMARY OF THE INVENTION

In view of the foregoing background, it is therefore an object of the present invention to reduce an undesired axial magnetic field component created at the ends of a stator.

This and other objects, features, and advantages of the present invention are provided by a power generator comprising at least one counteracting magnetic field generator for generating a counteracting magnetic field to counteract an undesired axial magnetic field component. More specifically, the power generator may include a rotor, and a stator surrounding the rotor and having opposing ends. The stator may comprise a stator core and a plurality of windings carried by the stator core creating the undesired axial magnetic field component adjacent the opposing ends of the stator. The counteracting magnetic field generator may be associated with at least one end of the stator for generating a counteracting magnetic field for counteracting the undesired axial magnetic field component. Accordingly, by counteracting the undesired axial magnetic field component, eddy currents and associated heating may be reduced.

The counteracting magnetic field generator may comprise a first electrically conductive coil portion positioned for having an electrical current induced therein by the rotor, and a second electrically conductive coil portion positioned adjacent an end of the stator and connected to the first electrically conductive coil portion to receive the electrical current therefrom to generate the counteracting magnetic field. The stator may be spaced from the rotor to define a gap therebetween, and the first electrically conductive coil portion may be positioned in the gap in these embodiments. Alternately, or additionally, the stator core may include a recess therein receiving the first electrically conductive coil portion.

The windings may comprise end windings extending outwardly beyond respective ends of the stator core, and the second electrically conductive coil portion may be positioned adjacent at least one of the end windings. Relative positioning of the first and second electrically conductive coil portions may provide a desired phase offset for the counteracting magnetic field.

In other embodiments, the counteracting magnetic field generator may alternately comprise an electrically conductive coil portion adjacent an end of the stator, and a power source connected to the electrically conductive coil portion to generate the counteracting magnetic field. The power generator may further comprise at least one magnetic field sensor, and the power source may comprise a controller for controlling the counteracting magnetic field based upon the at least one magnetic field sensor. The controller may provide a desired phase offset for the counteracting magnetic field.

In addition to the counteracting magnetic field generator, the stator core may have at least one step at each end thereof, and/or a magnetic field shunt adjacent each end of the stator. This may further enhance the reduction of the undesired axial magnetic field component.

A method aspect of the present invention is for counteracting an undesired axial magnetic field component adjacent at least one end of a stator. The method may comprise generating a counteracting magnetic field adjacent the at least one end of the stator to counteract the undesired axial magnetic field component.

### BRIEF DESCRIPTION OF THE DRAWINGS

FIG. 1 is schematic block diagram of a power generating apparatus including a counteracting magnetic field generator according to the present invention.

FIG. 2 is a schematic transverse cross-sectional view of an end portion of the stator of the power generator shown in FIG. 1 illustrating an undesired axial magnetic field component, and the counteracting magnetic field produced by the counteracting magnetic field generator.

FIG. 3 is a schematic transverse cross-sectional view of the power generator shown in FIG. 1.

FIG. 4 is a schematic transverse cross-sectional view of the second embodiment of the counteracting magnetic field generator according to the present invention.

FIG. 5 is a schematic end view of stator end windings of a stator illustrating a second embodiment of the counteracting magnetic field generator according to the present invention.

FIGS. 6-10 are schematic plan views of an interior surface of the stator showing additional embodiments of electrically conductive coil portions of the counteracting magnetic field generator according to the present invention.

FIGS. 11-12 are schematic diagrams of two other embodiments of the electrically conductive coils of the counteracting magnetic field generator according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

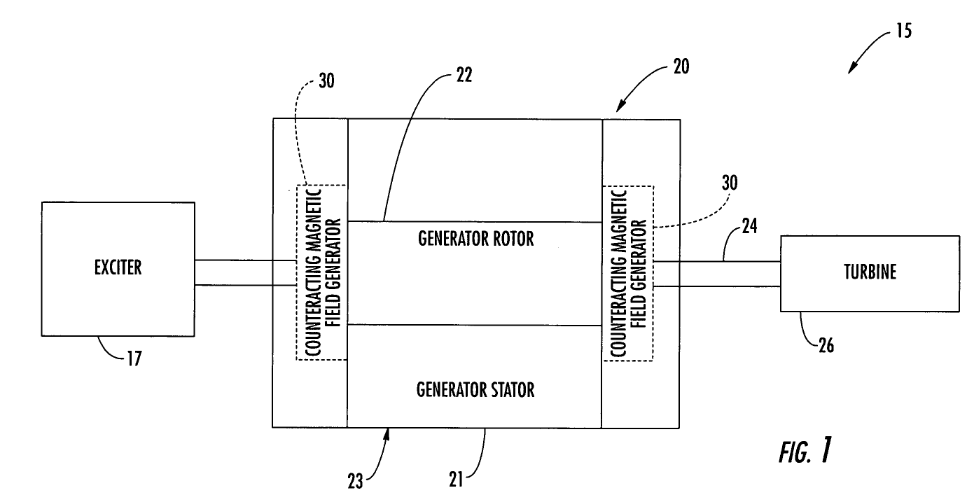

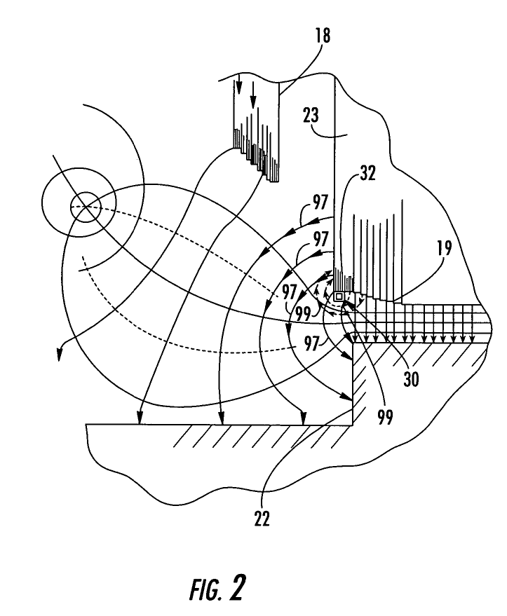

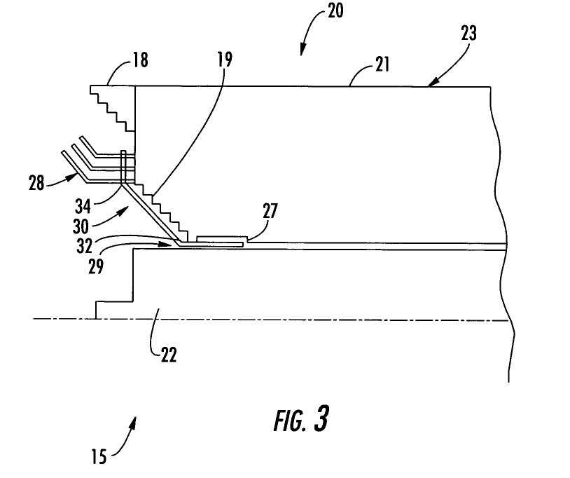

Referring initially to FIGS. 1-3, a power generating apparatus 15 including a counteracting magnetic field generator 30 is now described. The power generating apparatus 15 illustratively includes a power generator 20 and an exciter 17 connected thereto. More particularly, the power generator 20 includes a generator rotor 22 and a generator stator 23 surrounding the generator rotor. The generator rotor 22 is mounted to a shaft 24 that is driven by a turbine 26. The turbine 26 may be a steam turbine, gas turbine, or water turbine as will be appreciated by those skilled in the art. The counteracting magnetic field generator 30 is illustratively positioned adjacent both ends of the stator 23 (FIG. 1) to generate a counteracting magnetic field 99. The counteracting magnetic field 99 counteracts an undesired axial magnetic field component 97 (FIG. 2) caused by windings of the stator 23 and windings of the rotor 22. Those skilled in the art will appreciate that the counteracting magnetic field generator 30 may also be positioned adjacent only one end of the stator 23.

The stator 23 illustratively has opposing ends, and comprises a stator core 21 having laminations. The stator 23 surrounds the rotor 22, and an undesired axial magnetic field component 97 may be created adjacent the opposing ends of the stator. The counteracting magnetic field generator 30 is associated with at least one end of the stator 23 for generating a counteracting magnetic field 99 for counteracting the undesired axial magnetic field component 97. More particularly, the counteracting magnetic field generator 30 may be positioned at the end of the stator core 21 between the laminations, as will be readily appreciated by those skilled in the art. Accordingly, by counteracting the undesired axial magnetic field component 97, eddy currents and undesired heating are reduced.

The stator 23 is illustratively spaced from the rotor 22 to define a gap 29 therebetween, and illustratively comprises a plurality of windings 28. The counteracting magnetic field generator 30 may illustratively be positioned in the gap 29. More specifically, the counteracting magnetic field generator 30 illustratively includes first and second electrically conductive coil portions 32, 34. The first electrically conductive coil portion 32 is positioned for having an electrical current induced therein by the rotor 22, and the second electrically conductive coil portion 34 is positioned adjacent an end of the stator 23 and connected to the first electrically conductive coil portion to receive the electrical current therefrom to generate the counteracting magnetic field.

More particularly, the first electrically conductive coil portion 32 is positioned in the gap 29. The stator core 21 may include a recess 27 therein receiving the first electrically conductive coil portion 32. The stator core 21 may also have a stepped portion 19 at an end thereof, and may comprise a magnetic field shunt 18 adjacent an end of the stator core 21. Of course, those skilled in the art will appreciate that the stepped portion 19 and the magnetic field shunt 18 may be positioned adjacent each end of the stator core 21. The stepped portion 19 and the magnetic field shunt 18 advantageously reduce eddy currents and undesired heating of the power generator 20.

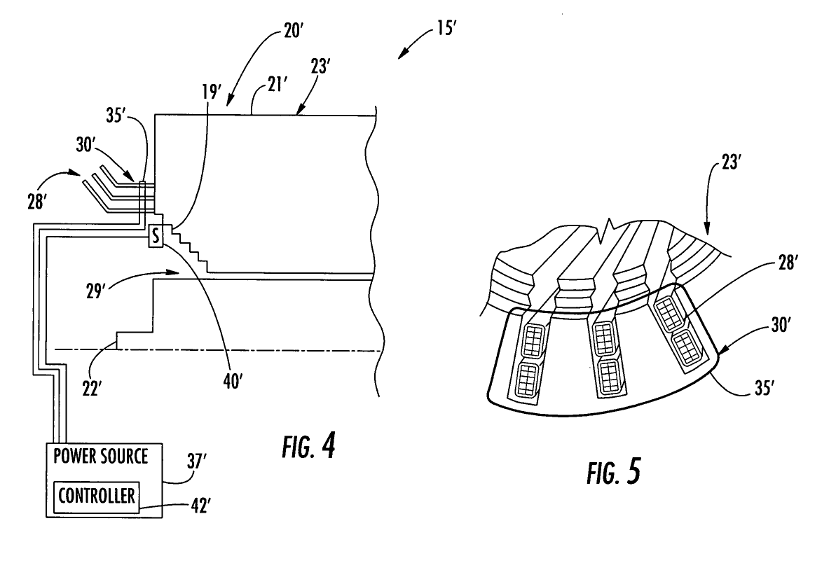

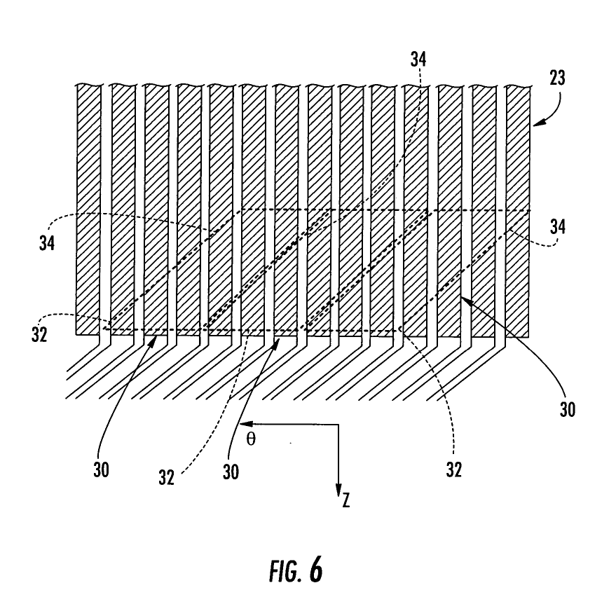

Referring now additionally to FIGS. 4-5, a second embodiment of the power generator 20′ is now described. In the second embodiment of the power generator 20′, the plurality of windings 28′ carried by the stator core 21′ create an undesired axial magnetic field component adjacent the opposing ends of the stator 23′. The counteracting magnetic field generator 30′ may illustratively surround the windings 28′. The counteracting magnetic field generator 30′ illustratively includes a conductive coil portion 35′ adjacent an end of the stator 23′. The counteracting magnetic field generator 30′ also includes a power source 37′ connected to the electrically conductive coil portion 35′ to generate the counteracting magnetic field.

The power generator 20′ comprises a magnetic field sensor 40′, and the power source 37′ comprises a controller 42′ for controlling the counteracting magnetic field based upon the magnetic field sensor. The power source 37′ may provide a desired phase offset for the counteracting magnetic field. The other elements of this embodiment of the power generator 20′ are similar to those of the first embodiment of the power generator 20, are labeled with prime notation, and require no further discussion herein.

Referring now additionally to FIGS. 6-10, embodiments of the counteracting magnetic field generator 30 are now described in greater detail. A first embodiment of the first and second electrically conductive coil portions are labeled as above, i.e., 32, 34. The alternate embodiments of the first and second electrically conductive coil portions 32, 34 are labeled as increasing in numbering by 100 for each alternate embodiment. Further, a graphical illustration is provided if FIGS. 6-10 to note direction, in which Θ represents the peripheral direction, and Z represents the axial direction. Relative positioning of the first and second electrically conductive coil portions 32, 34 provide a desired phase offset for the counteracting magnetic field.

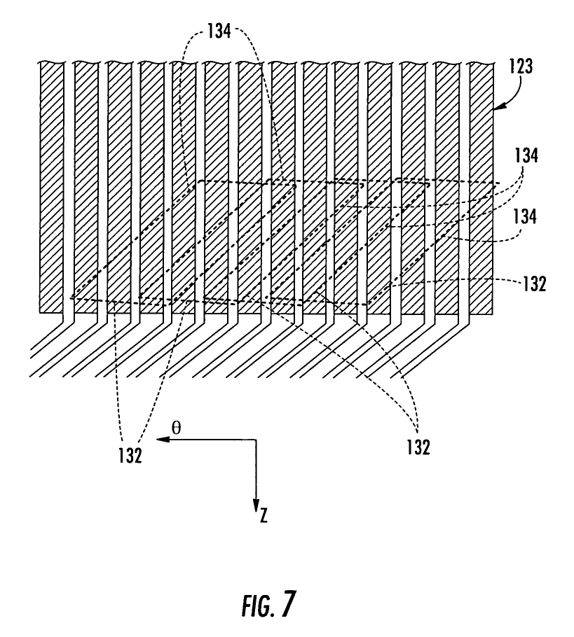

Referring more specifically to FIG. 6, for example, a plurality of first and second electrically conductive coil portions 32, 34 are illustrated. The plurality of first and second electrically conductive coil portions 32, 34 each have a polygonal shape, and are arranged in side-by-side relation along the interior surface of the stator 23. FIG. 7 illustrates another embodiment of the plurality of first and second electrically conductive coil portions 132, 134. The plurality of first and second electrically conductive coil portions 132, 134 also have a polygonal shape, but are slightly more slanted than the plurality of first and second electrically conductive coil portions 32, 34 illustrated in FIG. 6. Further, the plurality of first and second electrically conductive coil portions 132, 134 illustrated in FIG. 7 may be overlapped along the interior surface of the stator 123.

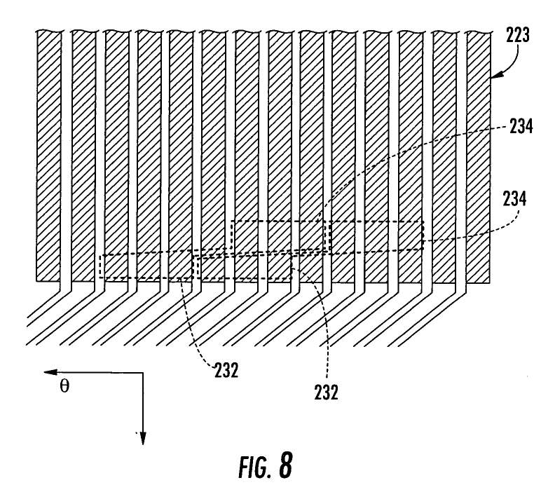

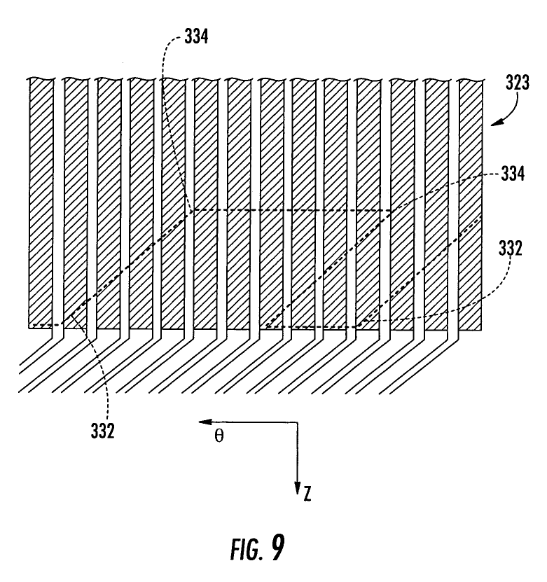

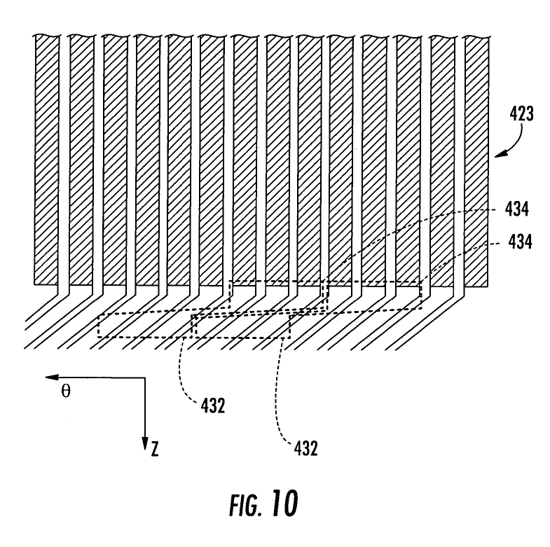

In FIG. 8, a pair of first and second electrically conductive coil portions 232, 234 is illustrated, each having opposing polygonally shaped ends, and arranged in side-by-side relation along the interior surface of the stator 223. In FIG. 9, the first and second electrically conductive coil portions 332, 334 are arranged in an end-to-end linear format along an inner surface of the stator 323. In FIG. 10, the configuration of the pair of first and second electrically conductive coil portions 432, 434, is similar to that of the pair of first and second electrically conductive coil portions 232, 234 illustrated in FIG. 8, and are positioned along a lower portion of the interior surface of the stator 423.

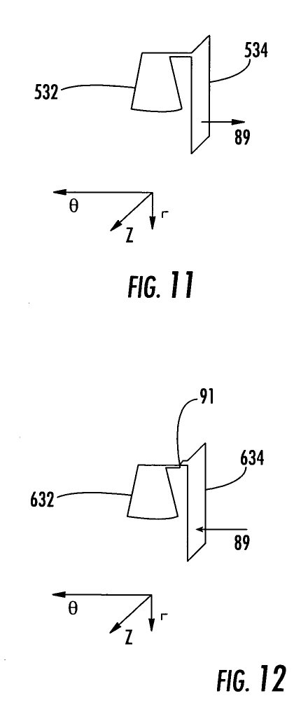

Referring now additionally to FIGS. 11-12, further embodiments of the first and second electrically conductive coil portions 532, 534 and 632, 634 are now described in greater detail. In FIG. 11, the arrow 89 indicates the main stator core flux. Accordingly, the first and second electrically conductive coil portions 532, 534 are arranged in a loop configuration having polygonally shaped portions. In FIG. 12, an opposing main stator core flux 89 is illustrated. Accordingly, a cross-over point 91 joins the first and second electrically conductive coil portions 632, 634. In FIGS. 11 and 12, a graphical illustration of direction is provided in which Θ represents the peripheral direction, Z represents the axial direction, and R represents the radial direction.

A method aspect of the present invention is for counteracting an undesired axial magnetic field component adjacent at least one end of a stator 23. The method may comprise generating a counteracting magnetic field adjacent the at least one end of the stator 23 to counteract the undesired axial magnetic field component.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A power generator comprising:
a rotor;
a stator surrounding said rotor and having opposing ends, said stator comprising a stator core and a plurality of windings carried by said stator core creating an undesired axial magnetic field component adjacent the opposing ends of said stator; and
at least one counteracting magnetic field generator associated with at least one end of said stator for generating a counteracting magnetic field for counteracting the undesired axial magnetic field component.

2. A power generator according to claim 1 wherein said at least one counteracting magnetic field generator comprises:
a first electrically conductive coil portion positioned for having an electrical current induced therein by said rotor; and
a second electrically conductive coil portion positioned adjacent the at least one end of said stator and connected to the first electrically conductive coil portion to receive the electrical current therefrom to generate the counteracting magnetic field.

3. A power generator according to claim 2 wherein said stator is spaced from said rotor to define a gap therebetween; and wherein said first electrically conductive coil portion is positioned in the gap.

4. A power generator according to claim 2 wherein said stator core includes a recess therein receiving said first electrically conductive coil portion.

5. A power generator according to claim 2 wherein said windings comprise end windings extending outwardly beyond respective ends of said stator core; and wherein said second electrically conductive coil portion is positioned adjacent at least one end winding.

6. A power generator according to claim 2 wherein relative positioning of said first and second electrically conductive coil portions provides a desired phase offset for the counteracting magnetic field.

7. A power generator according to claim 1 wherein said at least one counteracting magnetic field generator comprises:
an electrically conductive coil portion adjacent the at least one end of said stator; and
a power source connected to said electrically conductive coil portion to generate the counteracting magnetic field.

8. A power generator according to claim 7 further comprising at least one magnetic field sensor; and wherein said power source comprises a controller for controlling the counteracting magnetic field based upon said at least one magnetic field sensor.

9. A power generator according to claim 7 wherein said power source provides a desired phase offset for the counteracting magnetic field.

10. A power generator according to claim 1 wherein said stator core has at least one step at each end thereof.

11. A power generator according to claim 1 further comprising a magnetic field shunt adjacent each end of said stator core.

12. A counteracting magnetic field generator for a power generator comprising a rotor and a stator surrounding the rotor and having opposing ends, the stator comprising a stator core and a plurality of windings carried by the stator core creating an undesired axial magnetic field component adjacent the opposing ends of the stator, the counteracting magnetic field generator generating a counteracting magnetic field for counteracting the undesired axial magnetic field component at at least one end of the stator and comprising:
a first electrically conductive coil portion positioned for having an electrical current induced therein by the rotor; and
a second electrically conductive coil portion positioned adjacent the at least one end of the stator and connected to said first electrically conductive coil portion to receive the electrical current therefrom to generate the counteracting magnetic field.

13. A counteracting magnetic field generator according to claim 12 wherein the stator is spaced from the rotor to define a gap therebetween; and wherein said first electrically conductive coil portion is positioned in the gap.

14. A counteracting magnetic field generator according to claim 12 wherein the stator core includes a recess therein receiving said first electrically conductive coil portion.

15. A counteracting magnetic field generator according to claim 12 wherein the windings comprise end windings extending outwardly beyond respective ends of the stator core; and wherein said second electrically conductive coil portion is positioned adjacent at least one end winding.

16. A counteracting magnetic field generator according to claim 12 wherein relative positioning of said first and second electrically conductive coil portions provides a desired phase offset for the counteracting magnetic field.

17. A counteracting magnetic field generator for a power generator comprising a rotor and a stator surrounding the rotor and having opposing ends, the stator comprising a stator core and a plurality of windings carried by the stator core creating an undesired axial magnetic field component adjacent the opposing ends of the stator, the counteracting magnetic field generator generating a counteracting magnetic field for counteracting the undesired axial magnetic field component at at least one end of the stator and comprising:
an electrically conductive coil portion adjacent an end of the stator; and
a power source connected to said electrically conductive coil portion to generate the counteracting magnetic field.

18. A counteracting magnetic field generator according to claim 17 further comprising at least one magnetic field sensor; and wherein said power source comprises a controller for controlling the counteracting magnetic field based upon said at least one magnetic field sensor.

19. A counteracting magnetic field generator according to claim 17 wherein said power source provides a desired phase offset for the counteracting magnetic field.

20. A method for counteracting an undesired axial magnetic field component adjacent at least one end of a stator surrounding a rotor, the undesired axial magnetic field component created by a plurality of windings carried by a stator core of the stator, the method comprising:
generating a counteracting magnetic field adjacent the at least one end of the stator to counteract the undesired axial magnetic field component.

21. A method according to claim 20 wherein generating comprises:
inducing an electrical current in a first electrically conductive coil portion;
connecting a second electrically conductive coil portion to the first electrically conductive coil portion to receive the electrical current therefrom to generate the counteracting magnetic field; and
positioning the second electrically conductive coil portion adjacent the at least one end of the stator.

22. A method according to claim 21 further comprising positioning the first electrically conductive coil in a gap between the stator and the rotor.

23. A method according to claim 21 further comprising positioning the first electrically conductive coil portion in a recess in the stator core.

24. A method according to claim 21 wherein the windings comprise end windings; and further comprising positioning the second electrically conductive coil portion adjacent at least one end winding.

25. A method according to claim 21 wherein relative positioning of the first and second electrically conductive coil portions provides a desired phase offset for the counteracting magnetic field.

26. A method according to claim 20 wherein generating comprises:
positioning an electrically conductive coil portion adjacent and end of the stator; and
connecting a power source to the electrically conductive coil to generate the counteracting magnetic field.

27. A method according to claim 26 further comprising controlling the counteracting magnetic field based upon at least one magnetic field sensor.

28. A method according to claim 26 wherein the power source provides a desired phase offset for the counteracting magnetic field.
